(19) United States
(12) Patent Application Publication
(10) Pub. No.: US 2012/0315070 A1
(43) Pub. Date: Dec. 13, 2012

(54) IMAGE FORMING APPARATUS

(75) Inventor: Masaharu HARASHIMA, Tokyo (JP)

(73) Assignee: KONICA MINOLTA BUSINESS TECHNOLOGIES, INC., Tokyo (JP)

(21) Appl. No.: 13/463,963

(22) Filed: May 4, 2012

(30) Foreign Application Priority Data
Jun. 8, 2011 (JP) 2011-127900

(51) Int. Cl. G03G 15/20

(52) U.S. Cl. 399/341

(57) ABSTRACT

An image forming apparatus is described. A sheet is transported from a sheet cooling unit 50, turned downwards in a U-turn through a U-shaped transportation guide member 61, and transported to a sheet reversing conveyance unit 60 which is located below the sheet cooling unit 50. The sheet reversing conveyance unit 60 reverses the sheet through a U-shaped reversing guide member 63 and transports the sheet to a main conveyance unit 40 which is on the upstream side of an image forming unit 10.

### CROSS-REFERENCE TO RELATED APPLICATIONS

The present application claims priority under 35 U.S.C. §119 to Japanese Patent Application No. P2011-127900, filed Jun. 8, 2011. The contents of this application are herein incorporated by reference in their entirety.

### FIELD OF INVENTION

The present invention relates to an image forming apparatus such as a copying machine, a printer, a facsimile machine, and a multi-functional peripheral.

### BACKGROUND OF THE INVENTION

Image forming apparatuses such as a copying machine, a printer, are provided with a blower fan for cooling printed sheets after forming images. However, in the case of machines which are driven at high linear speeds such as a high-speed production printer, the temperature of printed sheets cannot be effectively lowered even by a blower fan. Because of this, machines driven at high linear speeds are provided with a contact-type cooling device, for example, as described in Japanese Patent Published Application No. 2008-112102 so that printed sheets are forcibly cooled.

An image forming apparatus has the capability not only of forming images on one side of a sheet but also of forming images on both sides of a sheet. When the image forming apparatus performs such duplex printing, the sheet is reversed after image formation on one side by a sheet reversing mechanism which is located on the downstream side of a sheet cooling unit.

This sheet reversing mechanism may be located below the sheet cooling unit for the purpose of making the image forming apparatus smaller. However, if the print coverage of the image printed on a sheet is high, the remaining heat on the printed sheet is still high even after cooling. The heat from the surface of the sheet can thereby affect the cooling performance of the sheet cooling unit.

### SUMMARY OF THE INVENTION

To achieve at least one of the abovementioned objects, an image forming apparatus reflecting one aspect of the present invention comprises the image forming apparatus of forming images on both sides of a sheet comprising: a main conveyance unit configured to transport the sheet along a main transportation route; an image forming unit configured to forming an image on the sheet transported by said main conveyance unit; a sheet cooling unit configured to cool the sheet on which the image is formed by said image forming unit; and a sheet reversing conveyance unit configured to reverse the front and back sides of the sheet, wherein said sheet reversing conveyance unit is located below said sheet cooling unit, and the sheet output from said sheet cooling unit is transported to said sheet reversing conveyance unit by a U-shaped transportation guide member.

### BRIEF DESCRIPTION OF THE DRAWINGS

FIG. 1 is a view for showing the overall configuration of the image forming apparatus according to the present invention.

FIG. 2 is a schematic view for showing the key parts of a first embodiment of the present invention.

FIG. 3 is a schematic view for showing the key parts of a second embodiment of the present invention.

FIG. 4 is a side view as seen from arrow A in FIG. 3.

FIG. 5 is a schematic view for showing the sheet reversing process according to the second embodiment of the present invention.

### DETAILED DESCRIPTION OF THE PREFERRED EMBODIMENT

Hereinafter, a description is given of embodiments of the present invention with reference to the drawings.

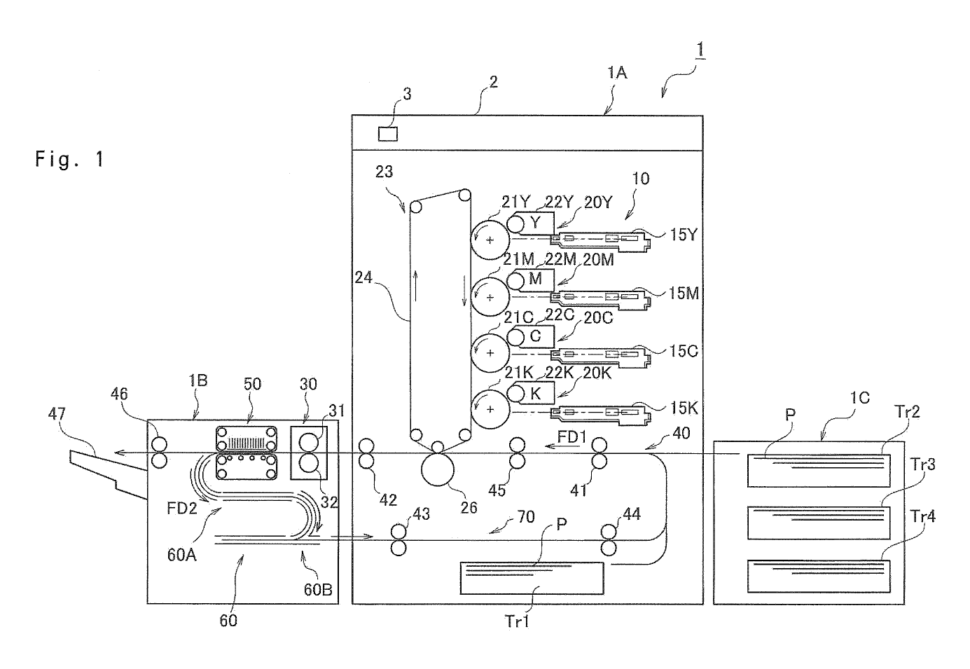

FIG. 1 shows an image forming apparatus 1, for example, a copying machine which is an electrophotographic image forming apparatus called a tandem color image forming apparatus. The tandem color image forming apparatus includes a plurality of photoreceptor drums vertically arranged in contact with one intermediate transfer belt to form full-color images. The image forming apparatus 1 is provided with a first main body 1A which is centrally located, a second main body 1B which is located on the left side of the first main body 1A in FIG. 1, and a paper feed unit 1C which is located on the right side of the first main body 1A.

The image forming apparatus 1 is comprised mainly of an original reading unit 2, an image forming unit 10, a fixing unit 30, a main conveyance unit 40, a sheet cooling unit 50 and a sheet reversing conveyance unit 60.

The image forming unit 10 is located in the first main body 1A. The fixing unit 30 is located in the second main body 1B as well as the sheet cooling unit 50 and the sheet reversing conveyance unit 60. However, the fixing unit 30 can be located in the first main body 1A together with the image forming unit 10.

The original reading unit 2 is provided with an automatic document feeder installed on the top of the first main body 1A so that, while successively feeding originals, image signals can be obtained by scanning the image of each original.

The image of each original is irradiated with a lamp by the original reading unit 2 so that the light reflected from the image is focused on the light receiving surface of an imaging device. The imaging device photoelectrically converts the incident light to image signals in a predetermined format and outputs them to an image reading control unit 3. The image reading control unit 3 processes the image signals by performing A/D conversion, shading compensation, data compression and so on, and outputs the processed image signals to a main control unit. Incidentally, the image data input to the main control unit is not limited to the image data as captured by the original reading unit 2, but can be the data for example as received from another image forming apparatus, a personal computer or the like connected to the image forming apparatus 1.

The image forming unit 10 forms a toner image on the basis of the image data, and transfers the toner image to a sheet of paper P. The image forming unit 10 generally includes exposure units 15Y, 15M, 15C and 15K, charging/developing units 20Y, 20M, 20C and 20K, an intermediate transfer unit 23 and a second transfer roller 26.

Each of the exposure units 15Y to 15K includes a laser source, a polygon mirror, a plurality of lenses and so on. The exposure units 15Y to 15K scans and exposes the surfaces of the photoreceptor drums 21Y, 21M, 21C and 21K respectively with laser beams in correspondence with the output information which is output from the main control unit on the basis of the image data. This scanning exposure process forms latent images on the photoreceptor drums 21Y to 21K respectively.

The charging/developing unit 20Y is comprised mainly of the photoreceptor drum 21Y which rotates around a rotation axis, and a charging/developing device 22Y which is located near the periphery of the photoreceptor drum 21Y. The charging/developing unit 20Y forms a toner image corresponding to yellow on the photoreceptor drum 21Y. The other charging/developing units 20M, 20C and 20K have the similar structure as the charging/developing unit 20Y, and have charging/developing devices 22M, 22C and 22K near the peripheries of the photoreceptor drums 21M, 21C and 21K respectively. The other charging/developing units 20M, 20C and 20K form toner images corresponding to magenta, cyan and black on the photoreceptor drums 21M, 21C and 21K respectively.

The surfaces of the photoreceptor drums 21Y to 21K are uniformly charged with electricity by the charging/developing devices 22Y to 22K, and the exposure units 15Y to 15K form latent images on these surfaces respectively.

The charging/developing devices 22Y to 22K visualize the latent images on the photoreceptor drums 21Y to 21K by developing the images with toner.

Toner images are thereby formed on the photoreceptor drums 21Y to 21K respectively. The toner images are transferred to predetermined locations of an intermediate transfer belt 24, which constitutes the intermediate transfer unit 23.

The second transfer roller 26 transfers the toner images, which are transferred to the intermediate transfer belt 24, to the sheet P transported with a predetermined timing by the main conveyance unit 40.

The sheet P with the transferred toner images, i.e., the sheet P carrying the toner images which have not yet been fixed is transported to the fixing unit 30.

The fixing unit 30 fixes the toner images to the sheet P by applying a pressure and heat to the sheet P. The fixing unit 30 is comprised for example of an upper fixing roller 31 and a lower fixing roller 32. The upper fixing roller 31 and the lower fixing roller 32 are located in contact with each other and urged against each other to form a fixing nip portion therebetween. A heater is installed in the upper fixing roller 31 as a heating unit for performing heat fixing. The upper fixing roller 31 is heated by heat of radiation from the heater.

The sheet P is transported and passed through the fixing nip portion with the unfixed images on the surface thereof facing the upper fixing roller 31. The toner images on the sheet P are fixed to the sheet P by a pressure and heat of the upper fixing roller 31.

The imaging unit 10 and the fixing unit 30 of the present embodiment cooperate as an image forming unit.

Namely, the image forming unit serves to (1) charge the photoreceptor drums 21Y to 21K, (2) form electrostatic latent images on the photoreceptor drums 21Y to 21K with the exposure units 15Y to 15K, (3) makes toner adhere to the electrostatic latent images as formed, (4) transfer the toner images from the photoreceptor drums 21Y to 21K to the intermediate transfer belt 24 as a first transfer process, (5) transfer the toner images from the intermediate transfer belt 24 to the sheet P as a second transfer process, and (6) fix the toner images to the sheet P. The image forming unit successively performs these processes to form the toner images on the sheet P transported by the main conveyance unit 40.

The main conveyance unit 40 includes a guide unit and a plurality of rollers arranged along a predetermined transportation route (hereinafter referred to as a main transportation route) which is designed to form images on the sheet P. The main transportation route 40 extends from the first main body 1A to the second main body 1B. When the sheet P is fed from the paper feed tray Tr1 of the first main body 1A or from the paper feed trays Tr2 to Tr4 of the paper feed unit 10, the main conveyance unit 40 transports the sheet P along the main transportation route. The main conveyance unit 40 defines a paper transportation direction FD1 corresponding to the direction (secondary scanning direction) perpendicular to the main scanning direction of toner images on the sheet P.

When the sheet P is transported along the main transportation route, the main conveyance unit 40 feeds the sheet P to the image formation position in the image forming unit. The sheet P is fed to the secondary transfer position, where a toner image is transferred to the sheet P, by the conveyance roller 41 and a resist roller 45, and fed to the fixing unit 30, which fixes the toner images to the sheet P, by the conveyance roller 42.

After passing through the secondary transfer position and fixing position, the sheet P is transported to the sheet cooling unit 50. The sheet P is cooled by the sheet cooling unit 50, and then guided by the guide unit to a sheet ejection roller 46 which discharges the sheet P to a copy receiving tray 47 attached to the external side of the second main body 1B.

When toner images are formed on both the front and back sides of the sheet P, the main conveyance unit 40 transports the sheet P to the sheet reversing conveyance unit 60 after forming images on the main side and cooling.

The sheet reversing conveyance unit 60 includes a guide unit and a plurality of rollers arranged along a predetermined transportation route (hereinafter referred to as a reversing transportation route) which is designed to reverse the front and back sides of the sheet P. The sheet reversing conveyance unit 60 receives the sheet P from the main conveyance unit 40 on the downstream side of the sheet cooling unit 50, and then transports the sheet P along the reversing transportation route.

After reversing the front and back sides through the sheet reversing conveyance unit 60, the sheet P is transported to a re-feeding transportation route 70, and transported again to the image forming unit by conveyance rollers 43 and 44.

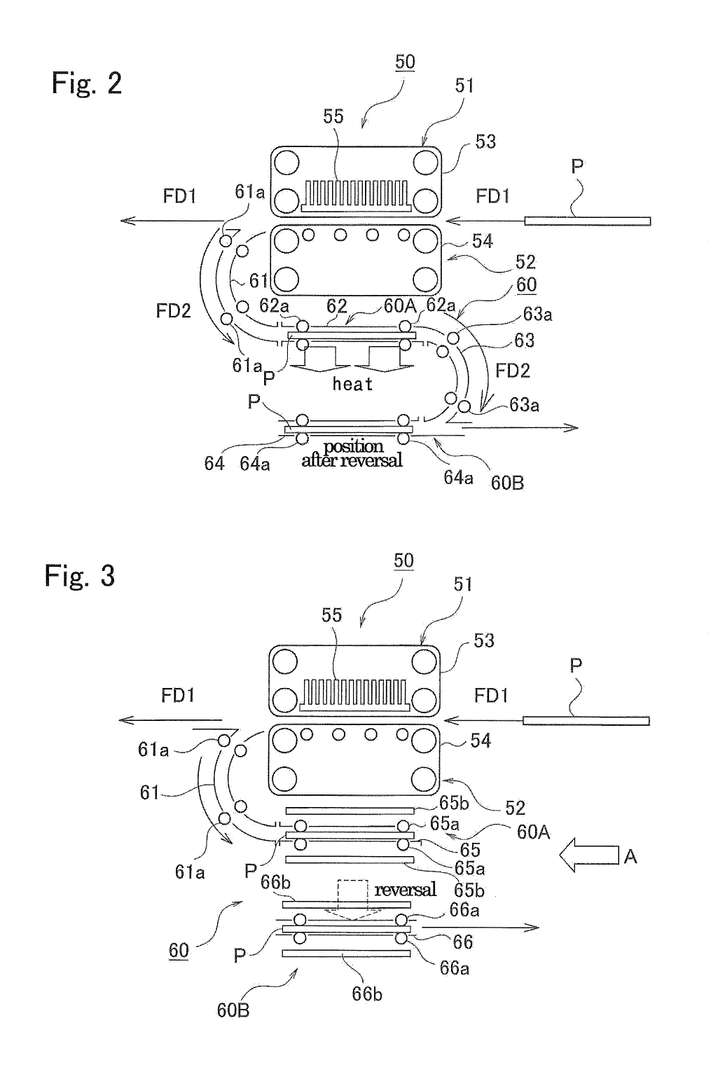

FIG. 2 schematically shows the structures of the sheet cooling unit 50 and sheet reversing conveyance unit 60.

The sheet cooling unit 50 is provided with a pair of upper and lower belt units 51 and 52. The sheet P transported from the fixing unit 30 is trapped between the belt units 51 and 52 and transported along the main transportation route by endless belts 53 and 54 being in close contact with the sheet P.

A heat sink 55 serves as a cooling device which is in contact with the back side of at least one of the endless belts 53 and 54. In FIG. 2, this cooling device is installed in the upper belt unit 51 and located on the back side of the endless belt 53. The sheet P heated by the fixing unit 30 is cooled while being transported between the belt units 51 and 52.

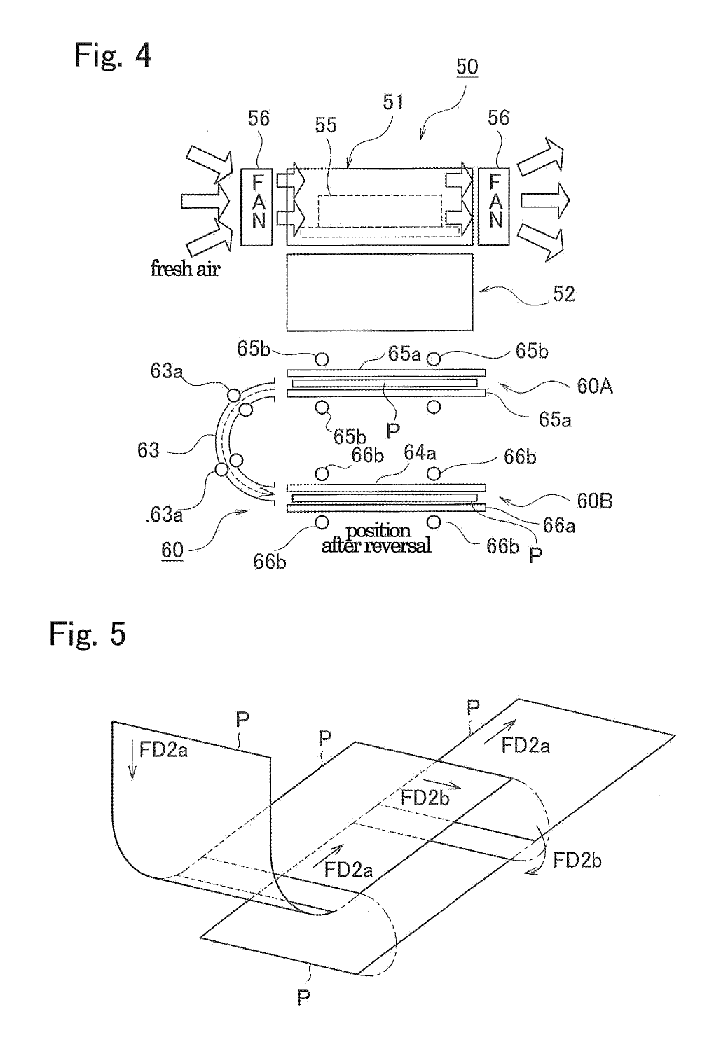

In order to perform heat dissipation from the heat sink 55, the belt unit 51 is designed to introduce cooling air through cooling fans 56 into the inside of the endless belt 53 (refer to FIG. 4).

The sheet reversing conveyance unit 60 is located below the sheet cooling unit 50 in the form of a vertical multistage structure including a first conveyance unit 60A as an upper stage and a second conveyance unit 60B as a lower stage.

The first conveyance unit 60A turns the sheet P output from the sheet cooling unit 50 in a U-turn as shown with arrow FD2, and guides the sheet P to the position below the sheet cooling unit 50.

The second conveyance unit 60B reverses the sheet P output from the first conveyance unit 60A to the position below the first conveyance unit 60A in a transfer direction as shown with arrow FD2. After reversing the front and back sides of the sheet P through the first and second conveyance unit 60A and 60B, the second conveyance unit 60B transports the sheet P to the main conveyance unit 40 which is located on the upstream side of the image forming unit. In the case of the example shown in FIG. 1, the second conveyance unit 60B transports the sheet P to the re-feeding transportation route 70, and transports the sheet P through the re-feeding transportation route 70 to the resist roller 45 which is located on the upstream side of the secondary transfer roller 26.

The sheet reversing conveyance unit 60 shown in FIG. 1 and FIG. 2 is provided with a sheet reversing switchback mechanism. The first conveyance unit 60A transports the sheet P to the second conveyance unit 60B which then performs switchback operation and returns the sheet P to the main conveyance unit 40.

The first conveyance unit 60A comprises a transportation guide member 61 and an upper guide member 62. The transportation guide member 61 is curved into a U shape to receive the sheet P output from the sheet cooling unit 50, turn the sheet P downwards in a U-turn, and transport the sheet P to the position below the sheet cooling unit 50. The upper guide member 62 is a flat member capable of transporting the sheet P and continued to the transportation guide member in a location below the sheet cooling unit 50. The transportation guide member 61 and the upper guide member 62 are provided with conveyance rollers 61a and 62a respectively.

The second conveyance unit 60B comprises a reversing guide member 63 and a lower guide member 64. The reversing guide member 63 is curved into a U shape to receive the sheet P output from the first conveyance unit 60A, turn the sheet P into the transfer direction FD2, and transport the sheet P to the position below the upper guide member 62. The lower guide member 64 is a flat member. The lower guide member 64 is located below the upper guide member 62, receives the sheet P output from the reversing guide member 63, performs switchback operation of the sheet P, and transports the sheet P to the re-feeding transportation route 70. The reversing guide member 63 and the lower guide member 64 constitutes a sheet reversing switchback mechanism. The reversing guide member 63 and the lower guide member 64 are provided with conveyance rollers 63a and 64a respectively.

The sheet P is cooled by the sheet cooling unit 50 and transported to the transportation guide member 61 which turns the sheet P downwards in a U-turn. The sheet P is thereby reversed with the printed front side being oriented downwards, and transported to the upper guide member 62. The sheet P is then output from the upper guide member 62 to the reversing guide member 63, and reversed by the reversing guide member 63. The sheet P is thereby reversed with the printed front side being oriented upwards, and transported to the lower guide member 64. The lower guide member 64 receives the sheet P, performs switchback operation of the sheet P to have the front side oriented upwards as it is, and transports the sheet P to the re-feeding transportation route 70. The position of the sheet in the lower guide member 64 is the position after reversing paper.

In accordance with the structure as described above, the image forming apparatus 1 has the sheet reversing conveyance unit 60 consisting of the upper first conveyance unit 60A and the lower second conveyance unit 60B in a location below the sheet cooling unit 50. Because of this, the second main body 1B can be compact, and thereby the image forming apparatus 1 can be compact as a whole.

The image forming apparatus 1 turns the sheet P output from the sheet cooling unit 50 downwards in a U-turn by the U-shaped transportation guide member 61 of the first conveyance unit 60A. Because of this, in the upper guide member 62, the printed surface of the sheet P is oriented downwards opposite the direction facing the sheet cooling unit 50. As a result, it is possible to reduce the radiation of heat retained on the printed surface of the sheet P toward the sheet cooling unit 50, and prevent the cooling performance of the sheet cooling unit 50 from being affected by the radiation.

The second conveyance unit 60B located in the lower stage of the sheet reversing conveyance unit 60 serves as a sheet reversing switchback mechanism which is constructed by the U-shaped reversing guide member 63 and the lower guide member 64. The sheet P can thereby be reversed by the switchback operation. This makes it possible to simplify the design of the system.

Alternatively, the sheet reversing switchback mechanism can be provided in the first conveyance unit 60A in place of the second conveyance unit 60B, so that the upper guide member 62 receives the sheet P output from the sheet cooling unit 50 and transports the sheet P to the second conveyance unit 60B by switchback operation. The second conveyance unit 60B then returns the sheet P reversed by the switchback operation to the main conveyance unit 40. However, in this case, the staying time of the sheet P in the first conveyance unit 60A becomes longer for the switchback operation of the sheet P.

The first conveyance unit 60A of the present embodiment turns the transportation direction of the sheet P downwards in a U-turn through the U-shaped transportation guide member 61. The sheet P is then passed through the upper guide member 62 with the printed surface being oriented downwards, and transported to the lower second conveyance unit 60B. The second conveyance unit 60B performs switchback operation through the reversing guide member 63 and the lower guide member 64. The staying time of the sheet P in the first conveyance unit 60A can therefore be shortened to effectively avoid adverse thermal effects on the sheet cooling unit 50.

FIG. 3 and FIG. 4 show the second embodiment of the present invention. FIG. 5 shows the transportation direction of the sheet P. The first conveyance unit 60A turns the sheet P through the transportation guide member 61 in the transportation direction FD2a. The second conveyance unit 60B then turns and the sheet P through the reversing guide member 63 in the transportation direction FD2b to reverse the sheet P. The direction FD2a is perpendicular to the direction FD2d. While the sheet P is passed through the first and second conveyance units 60A and 60B to reverse the front and back sides, the sheet P enters the image forming unit for printing the back side thereof with the same leading as for previously printing the front side thereof. In other words, the sheet reversing conveyance unit 60 provides a same-edge reversing transportation mechanism.

The first conveyance unit 60A comprises the first guide member 61 and the upper guide member 65. The first guide member 61 is curved into a U shape to turn the sheet P output from the sheet cooling unit 50 downwards in a U-turn, and transport the sheet P to the position below the sheet cooling unit 50. The upper guide member 65 is a flat member which receives the sheet P from the first guide member 61. The upper guide member 65 is provided with conveyance rollers 65a and 65b. The conveyance roller 65a transports the sheet P along the transportation direction FD2a. The conveyance roller 65b transports the sheet P along the transportation direction FD2b perpendicular to the transportation direction FD2a. The conveyance rollers 65a and 65b are alternately used when receiving and passing the sheet P respectively.

The second conveyance unit 60B comprises the reversing guide member 63 and the lower guide member 66. The reversing guide member 63 is curved into a U shape to reverse the sheet P output from the first conveyance unit 60A downwards in the transportation direction FD2b, and transport the sheet P to the position below the upper guide member 65. The lower guide member 66 is a flat member located below the upper guide member 65. The lower guide member 66 comprises the conveyance rollers 66a and 66b. The conveyance roller 66b transports the sheet P along the transportation direction FD2b. The conveyance roller 66a transports the sheet P to the transportation direction FD2a. The conveyance rollers 66a and 66b are alternately used when receiving and passing the sheet P respectively.

The sheet P is cooled by the sheet cooling unit 50 and transported to the U-shaped transportation guide member 61 which turns the sheet P downwards in a U-turn. The sheet P is thereby reversed with the printed front side being oriented downwards, and transported to the upper guide member 65.

The first conveyance unit 60A transports the sheet P from the transportation guide member 61 to the upper guide member 65 along the transportation direction FD2a. The transportation direction FD2a corresponds to the rotation of the sheet P in the rotation direction (generally referred to as the direction of the rotation axis) which is perpendicular to the main scanning direction.

The sheet P is transported from the upper guide member 65, and turned downwards by the reversing guide member 63 of the second conveyance unit 60B in the transportation direction FD2b which is perpendicular to the transportation direction FD2a of the transportation guide member 61. In other words, the rotation direction of the sheet P by the reversing guide member 63 is perpendicular to the rotation direction of the sheet P by the transportation guide member 61. The sheet P is placed on the lower guide member 66 with the front side thereof being oriented upwards, and transported to the re-feeding transportation route 70 with the leading edge thereof, which was also the leading edge when the sheet P entered the sheet reversing conveyance unit 60. Thus, the position of the sheet in the lower guide member 66 is the position after reversing paper.

Like in the first embodiment as described above, the image forming apparatus 1 of the second embodiment makes it possible to reduce the radiation of heat retained on the printed surface of the sheet P toward the sheet cooling unit 50, and prevent the cooling performance of the sheet cooling unit 50 from being affected by the radiation.

Particularly, in the case of this image forming apparatus 1, the accuracy of aligning images on the front and back sides of the sheet P can be improved by the same-edge reversing mechanism. Namely, the sheet P is reversed through the transportation route where the transportation direction FD2a is perpendicular to the reversing direction FD2b, so that the leading edge and the tail edge of the sheet P shall not be exchanged during reversing. As a result, the same edge of the sheet P is used as a positional reference both for printing images on the front and back sides of the sheet P, and thereby the accuracy of aligning images on the front and back sides can be improved.

As shown in FIG. 4, the reversing guide member 63 is located in the cooling air introduction side of the sheet cooling unit 50 where one of the cooling fans 56 for intaking air is located. In other words, the reversing guide member 63 is located on the upstream side of the cooling airflow introduced to the heat sink 55. The sheet P reversed by the reversing guide member 63 can thereby be prevented from being affected by exhaust heat of the cooling air after heat exchange through the heat sink 55.

The foregoing description has been presented on the basis of the embodiments. However, it is not intended to limit the present invention to the precise form described, and obviously many modifications and variations are possible without departing from the scope of the invention as well as any combination of these embodiments.

For example, while the image forming apparatus 1 has the first main body 1A, the second main body 1B and the paper feed unit 1C separately, the functional units implemented therein can be placed in a single housing.

Also, while the sheet cooling unit 50 is implemented with the heat sink 55, a heat pipe or Peltier device can be used for the same purpose.

What is claimed is:

1. An image forming apparatus of forming images on both sides of a sheet comprising:
a main conveyance unit configured to transport the sheet along a main transportation route;
an image forming unit configured to forming an image on the sheet transported by said main conveyance unit;
a sheet cooling unit configured to cool the sheet on which the image is formed by said image forming unit; and
a sheet reversing conveyance unit configured to reverse the front and back sides of the sheet,
wherein said sheet reversing conveyance unit is located below said sheet cooling unit, and the sheet output from said sheet cooling unit is transported to said sheet reversing conveyance unit by a U-shaped transportation guide member.

2. The image forming apparatus of claim 1 wherein
said U-shaped transportation guide member transports the sheet to said sheet reversing conveyance unit in order that the side of said sheet on which the image is formed is oriented downwards.

3. The image forming apparatus of claim 1 wherein
said sheet reversing conveyance unit is provided with a switchback-type sheet reversing mechanism which reverses said sheet through a U-shaped reversing guide member, performs switchback operation of said sheet, and transports said sheet to said main conveyance unit.

4. The image forming apparatus of claim 1 wherein
said sheet reversing conveyance unit is provided with a same-edge-type sheet reversing mechanism which reverses said sheet through a U-shaped reversing guide member in a direction perpendicular to the transportation direction of said sheet by said U-shaped transportation guide member, and transports said sheet to said main conveyance unit.

5. The image forming apparatus of claim 4 wherein said sheet cooling unit comprising:
a pair of endless belts configured to transport a sheet therebetween;
a cooling device configured to be in contact with the inner side of at least one of said endless belts;
a cooling fan configured to introduce cooling air to the inside of said one of said endless belts, and wherein
said U-shaped reversing guide member is located in the cooling air introduction side of said sheet cooling unit.
